(19) United States
(12) Patent Application Publication
(10) Pub. No.: US 2023/0079648 A1
(43) Pub. Date: Mar. 16, 2023

(54) EV CHARGING SYSTEM & METHOD

(71) Applicant: Steve Witters, La Grange, KY (US)

(72) Inventor: Steve Witters, La Grange, KY (US)

(21) Appl. No.: 17/476,422

(22) Filed: Sep. 15, 2021

(51) Int. Cl. B60L 53/16; H02J 7/00; B60L 53/35; B60L 53/62; B60L 53/66

(52) U.S. Cl. CPC B60L 53/16; H02J 7/0013; H02J 7/00032; H02J 7/0042; H02J 7/0047; B60L 53/35; B60L 53/62; B60L 53/66; B60L 53/11

(57) ABSTRACT

Presently disclosed is an EV charging system & method for charging EVs while the EVs are in motion. The charging system has a longitudinally extending charging strip or rail having at least one electrically charged length and an external power source in electrical connection with the at least one electrically charged length. At least one electrical connector is configured to electrically connect an EV to the at least one electrically charged length and charge the EV, while the EV and the electrical connector are moving along a length of the longitudinally extending charging strip or rail.

### FIELD OF INVENTION

The present invention relates to systems and methods for charging electrical vehicles, EVs, while the EVs are in motion.

### BACKGROUND OF THE INVENTION

EVs, or electric vehicles, are becoming common. Current infrastructure requires that the EV be stopped or parked at an available charging site for a period of time to recharge the EV batteries. The number of EVs that may be simultaneously charge at a charging station may be limited to a number of available charging sites at the charging station. It may be desired to charge a plurality of EVs simultaneously and not be limited to a number of available charging sites or it may be desired to charge EVs while the EVs are in motion.

### SUMMARY

The present invention relates to systems and methods for charging electrical vehicles, EVs, while the EVs are in motion.

In one embodiment of the present disclosure, an EV charging system is disclosed. The EV charging system has a longitudinally extending charging strip or rail having at least one electrically charged length. An external power source is in electrical connection with the at least one electrically charged length. At least one electrical connector is configured to electrically connect the EV to the longitudinally extending charging strip or rail and charge the EV, while the EV and a connected electrical connector are moving along a length of the longitudinally extending charging strip or rail.

In another embodiment of the present disclosure, an EV charging adapter is disclosed. The EV charging adapter has at least two electrical contacts configured and disposed to electrically connect with a longitudinally extending charging strip or rail, while the EV is moving about a length of the longitudinally extending charging strip or rail. Each of the electrical contacts being configured and disposed to supply power to the EV for charging.

In a further embodiment of the present disclosure, a method of charging an EV while the EV is in motion is disclosed. The method comprises placing the EV in a charging lane or position, obtaining a speed for charging, and disposing electrical contacts with the EV for charging. The disposed electrical contacts are electrically connected to electrically charged lengths and the EV is charged. Upon receiving a charge, the electrical contacts are disconnected from the electrically charged lengths.

### BRIEF DESCRIPTION OF THE DRAWINGS

The foregoing and other features of this disclosure will become more fully apparent from the following description and appended claims, taken in conjunction with the accompanying drawings and examples. Understanding that these drawings depict only illustrations of several embodiments in accordance with the disclosure and are therefore, not to be considered limiting of its scope. The disclosure will be described with additional specificity and detail through use of the accompanying drawings.

The following figures, which are idealized, are not to scale and are intended to be merely illustrative of aspects of the present disclosure and non-limiting. In the drawings, like elements may be depicted by like reference numerals. The drawings are briefly described as follows:

FIG. 1 shows an illustrative example of the presently disclosed EV charging system;

FIG. 2 shows illustrative examples of electrical connectors hat may be incorporated with the system shown in FIG. 1;

FIG. 3 shows illustrative examples of multi-component electrical connectors that may be incorporated with the system shown in FIG. 1;

FIG. 4 shows another illustrative example of an embodiment of an electrical connector, including an adapter, that may be used with the system shown in FIG. 1; and

FIG. 5 shows illustrative examples of existing charging ports disposed on EVs for wired charging.

### DETAILED DESCRIPTION OF THE INVENTION

Presently disclosed is an EV charging system and method that provides for the charging of EVs, while the EVs are in motion. For example, one or a plurality of EV(s) may be charged while the EVs are in motion, such as driving on a road or moving in a charging lane.

The presently disclosed system comprises a charging station in electrical contact with stationary power source or power supply. The charging system has one or more electrical connectors for electrically connecting EVs to the power source for charging. For example, the charging station may comprise a longitudinally extending charging strip or rail in electrical communication with the power source that provides energy for charging EVs. At least one electrical connector is configured to electrically connect an EV to the charging rail or strip while the vehicle is traveling along an energized length of the charging rail or strip.

The presently disclosed EV charging system may have one or more electrical connectors configured to supply power to an EV as it moves about the length of the longitudinally extending charging strip or rail. The system may have electrical connector(s) configured to be held with an EV, with the charging station, for example, with the longitudinally extending charging strip or rail, or both. In at least one embodiment, the system is configured to provide an electrical connection with EVs having an adapter configured to electrical connect with the longitudinally extending charging strip or rail. In at least one other embodiment, the charging system is configured to electrically connect with an EV's existing charging system. For example, an EV may have an electrical connector configured to extend therefrom and electrically communicate with the longitudinally extending charging strip or rail. In another example, an electrical connector may extend from the longitudinally extending charging strip or rail and may be adapted to electrically connect with an EV. For example, an electrical connector may extend from the longitudinally extending charging strip or rail and be configured to plug into the EV's existing charging receptacle or electrically connect with another portion of the EV's charging system. In a further embodiment, the EV holds a portion of an electrical connector, such as an adapter, and another portion of the electrical connector may be held with the charging station or longitudinally extending charging strip or rail.

The electrical connectors and the electrically charged lengths are configured to provide an electrical contact therebetween, as the EV and the electrical connector move about a length of the electrically charged lengths. For example, the electrical connectors may have contactors such as brushes or conductive rollers configured and disposed to provide an electrical contact with electrically charged lengths of the longitudinally extending charging strip or rail as the connector moves about a length of the strip or rail. Other and different electrical contactors, as are known by persons having ordinary skill in the art, may be provided with the presently disclosed electrical connectors or electrically charged lengths to provide a conductive electrical contact between the length of the stationary electrically charged lengths and the moving EV.

The longitudinally extending charging strip or rail may have one or more electrically charged lengths. For example, the strip or rail may have a positively charged length and a parallel extending negatively charged length for supplying an AC or DC current to the electrical connectors. The charged lengths are configured to become energized with an external power source and to electrically connect with an electrical connector for charging an EV.

The presently disclosed EV charging system may have one or more electrical connectors, wherein each electrical connector is configured to supply power to an EV as it moves about the length of the longitudinally extending charging strip or rail. The system may have electrical connectors, or portions of electrical connectors, configured to be held with an EV, with the longitudinally extending charging strip rail, or both, when the electrical connector is not connected to an EV. In at least one embodiment, the system is configured to provide an electrical connection with EVs having at least a portion of the electrical connector retained therewith. For example, an EV may have an electrical connector, or adapter, configured to electrically connect with the longitudinally extending charging strip or rail. In at least one other embodiment, the system is configured to provide an electrical connection with EVs void of an electrical connector. For example, an electrical connector may extend from the longitudinally extending charging strip or rail and may be adapted to connect to the EVs existing charging system, for example, plug into the EV's existing charging port.

In at least one further embodiment, a portion of an electrical connector is configured to be disposed with an EV and another portion is configured to be disposed with the charging station or the longitudinally extending charging strip or rail. For example, a portion of an electrical connector, or an adapter, may be adapted to connect with an existing EV charging system or charging port and be held with the EV. Another portion of the electrical connector may be adapted to electrically connect the portion of the electrical connector held with the EV to the longitudinally extending charging strip or rail.

Recently, EVs and DC fast chargers have been developed for charging with up to about 350 kW of DC power. Higher power chargers and EVs configured to accept the higher power charge may become available in the not too distant future. A greater supplied charging power will require less time to charge an EV to a desired level. The less time it takes to charge the EV to a desired level, a shorter length of charging rail or strip may be needed. Therefore, a greater charging power supply or source may be desired with the presently disclosed charging system.

In at least one embodiment of the present disclosure, the longitudinally extending charging strip or rail is configured to provide at least about 350 kW of DC power for each EV being charged. Currently, not all EVs are configured to be charged with 350 kW of power. Therefore, the system may be configured to provide different levels of power for charging different EVs having different charging power requirements. It is to be understood that the presently disclosed EV charging system may have a longitudinally extending charging strip or rail configured to provide between about 1 kW and 100000 kW of charging power, less than 1 kW, and more than 100000 kW, and is therefore not to be limited to any particular charging power for charging EVs. For example, 100000 kW may provide a sufficient energy to simultaneously charge an excess of 250 EVs at a rate of 350 kW or an excess of 100 EVs at a rate of 700 kW.

The length of the charging strip for a desired charge may be dependent upon the speed of the vehicle, the available charging energy source, and the efficiency and acceptable charging power/rate of the EV. Transmission lines may carry high voltage electricity at about 345,000V and may provide a stationary power or energy source in some areas. In one example, an EV having an efficiency of about 28 kWh/100 mi, traveling at 60 mph, and charging with 350 kW of DC power for about 5 minutes may require about 5 miles of a longitudinally extending charging strip or rail to supply the EV with about 100 miles of range. In another example, the EV traveling at 45 mph may require about 3.75 miles to supply the automobile with about 100 miles of range. In a further example, the EV traveling at 10 mph may require about 0.5 miles to supply the automobile with about 100 miles of range. In a yet another example, the EV traveling at 1 mph may require about 0.05 miles to supply the automobile with about 100 miles of range. As charging efficiencies (kWh/100 mi) and acceptable charging powers (kW) of EVs increase, the time to obtain a desired charge may decrease. These advancements may enable the presently disclosed system to charge EVs with longer range charges, at higher speeds, and/or with a shorter length of charging rail or strip.

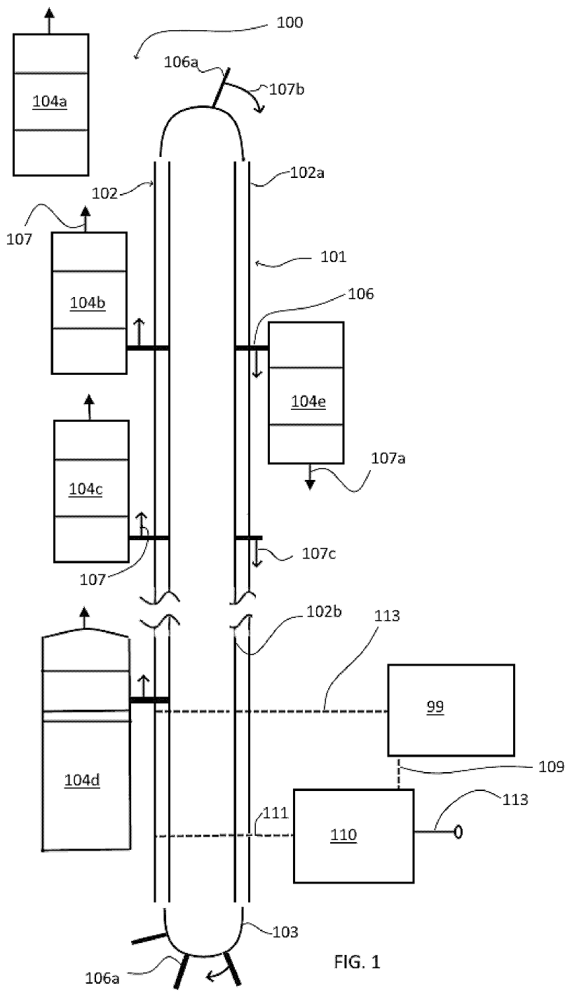

FIG. 1 shows an illustrative example of an EV charging system 100. Charging station 101 has longitudinally extending charging strip or rail 102 which may have lengths of electrical contacts. For example, charging strip or rail 102 may have a positively charged length, 102a or 102b, and a parallel extending negatively charged length, the other of 102a or 102b. The charged lengths, 102a and 102b, are configured to become energized with an external stationary power source or supply 99 and to electrically connect with one or more electrical connectors 106. Power source 99 and charging station 101 may be configured to provide at least 350 kW or at least 480V and 100 amps power to each EV being charged. Power station 99 may be configured to provide up to about 345,000V.

FIG. 1 shows charging system 100 having a plurality of electrical connectors 106 and 106a. A plurality of moving EVs may be charged simultaneously with the presently disclosed system. For example, EV 104b, 104c, 104d, and 104e may each simultaneously be electrically connected to a longitudinally extending charging strip or rail 102. EV 104b, 104c, and 104d, and their connected electrical connector 106, may be moving about a charged length, 102a and 102b, of longitudinally extending charging strip or rail 102 at substantially the same speed, as indicated with arrows 107. Charging station 101 may have more than one charging strip or rail 102. For example, EV 104e may be moving at a speed as indicated with arrow 107a, which may be at the same or different speed as indicated with arrow 107. EVs may depart from charging station 101 by simply moving away from longitudinally extending charging strip or rail 102, as indicated with EV 104a.

In at least one embodiment, EV charging system 100 comprises longitudinally extending charging strip or rail 102 having at least one electrically charged length, 102a and/or 102b. External power source 99 is in electrical connection with the at least one electrically charged length 102a and/or 102b. For example, external power source 99 may be directly connected with charged lengths 102a and 102b as indicated with connecting line 113. Alternatively, or additionally, external power source 99 may be connected with controller 110, as indicated with connecting line 109, and controller 110 may be connected to charged lengths 102a and 102b, as indicated with connecting line 111. At least one electrical connector 106 is configured and disposed to electrically connect an EV, EV 104b, 104c, and/or 104d, to the longitudinally extending charging strip or rail 102 and charge the EV(s), while the EV and a connected electrical connector 106 are moving along a length of the longitudinally extending charging strip or rail 102.

EV charging system 100 may have two or more electrical connectors 106 and may be configured to charge at least two EVs simultaneously, for example, EV 104b, 104c, 104d, and 104e, while each of the EVs are moving along a length of a longitudinally extending charging strip or rail 102. In at least one embodiment, longitudinally extending charging strip or rail 102 and external power source 99 are configured and disposed to provide at least 350 kW power to each of the EVs being charged.

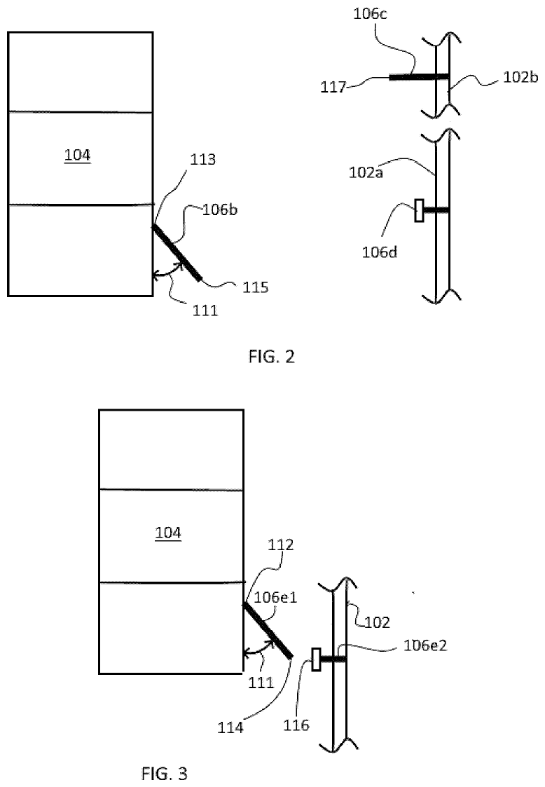

In at least one embodiment, at least a portion of an electrical connector 106, for example 106c, 106d, 106e2, as shown in FIGS. 2 and 3, is retained with longitudinally extending charging strip or rail 102 or queue 103, as indicated with electrical connector 106a, upon an EV becoming electrically disconnected from longitudinally extending charging strip or rail 102. The retained electrical connector 106, or portion thereof, may be returned, as indicated with arrows 107 and 107c, to a queue 103, as illustrated with electrical connector, or portion thereof, 106a. Electrical connectors 106 may be configured to provide a conductive electrical contact between an EV and longitudinally extending charging strip or rail 102. For example, the electrical contact for charging the EV with longitudinally extending charging strip or rail 102 may provide for conductive transfer of energy and be substantially void of less efficient inductive, or wireless, charging.

Charging system 100 may have controller 110 which may be configured to control the movement of electrical connectors 106 and 106a, or portions thereof. Controller 110 may be in wireless communication 113 and/or wired communication 111, with charging station 101 and/or one or more EVs. In at least one embodiment, controller 110 may be in wireless communication with approaching EVs and station 101. Approaching EVs may wirelessly communicate with controller 110 via wireless communicator 113. Upon receiving a request for charging from an approaching EV, system 100 may be configured to move an electrical connector, or portion thereof, 106a, out of queue 103 and onto longitudinally extending charging strip or rail 102. Controller 110 may be configured to cause an electrical connector 106, or portions thereof, to move at a speed 107 proximate the speed of the approaching EV and to charging station 101 to electrically connect with the EV for charging.

Controller 110 may be configured and disposed to condition, direct, and/or modulate power to charged lengths 102a and 102b from remote power source 99. Additionally or alternatively, electrical connector 106 may be configured and disposed to direct, condition, and/or modulate power to the EVs they are charging. In at least one embodiment, controller 110 is configured and disposed to control at least one of: a) an electrical connection between the EV being charged and the at least one electrically charged length; b) a power level to each of the EVs being charged, c) a speed of the at least one electrical connector about the longitudinally extending charging strip or rail; d) a position of the at least one electrical connector; e) a speed of the EV being charged; f) a position of the EV being charged; g) disconnecting the EV being charged from the longitudinally extending charging strip or rail; h) wirelessly receiving a request to charge the EV; and i) wirelessly sending a grant to charge the EV.

FIG. 2 shows illustrative examples of electrical connectors, or portions thereof, 106b, 106c, and 106d, that may be incorporated with system 100. For example, electrical connector 106b may have a portion configured to retract and extend, as illustrated with movement arrow 111, to and from, EV 104. Electrical connector 106b may be configured to electrically connect EV 104 and with charged lengths 102a and 102b. For example, electrical connector 106b may have a first end 113 configured to electrically connect with an existing charging system, or plug into an existing charging port, of EV 104 and a second end 115. Second end 115 may be configured to electrically connect with charged lengths 102a and 102b. For example, second end 115 may have brushes, magnetic contacts, or other different electrical contacts, as are known in the art, for providing conductive electrical contact with charged lengths 102a and 102b while EV 104 is moving. EV 104 may be manufactured to dispose electrical contacts for charging at charging station 101. For example, a first portion of an electrical connector may be a component part of the EV for charging at charging station 101.

Electrical connector 106c may have a portion configured to extend from charged lengths 102a and 102b and electrically connect with EV 104. For example, electrical connector 106c may have and end portion 117 configured to electrically connect with an existing charging system disposed with EV 104. In at least one embodiment, end portion 117 is configured to plug into an existing charging port disposed with EV 104.

Electrical connector 106d may be a portion of an electrical connector that is configured to electrically connect with another portion disposed with EV 104. For example, electrical connector 106d may be configured to electrically connect with electrical connector 106b disposed with, or extending, from EV 104.

FIG. 3 shows an illustrative example of a multi-component electrical connector that may incorporated with system 100. For example, an electrical connector 106 may have a first portion 106e1 configured to electrically connect with EV 104 for charging. First portion 106e1 may have a head 112 adapted to electrically connect with an existing charging system, such as a charging port, on EV 104, or other portion of EV 104. For example, charging ports disposed on EVs for wired charging come in a variety of configurations as shown in FIG. 5. First portion 106e1 may have a head 112 configured to electrically connect with, or plug into, an existing charging port disposed with EV 104. First portion 106e1 may be configured to be held with EV 104 and may be configured to be extended therefrom, as shown with movement arrow 111. Electrical connector 116e2 may be disposed with longitudinally extending charging strip or rail 102. Electrical connector 116e2 may have an end portion 116 configured and disposed to provide an electrical contact between electrical connector 106e1 and electrical connector 106e2, at end portion 114.

First portion 106e1 may be configured to deliver a specific charging power to EV 104. A plurality of EVs 104 may each have a first portion 106e1 configured to supply a desired charge to the EV to which they are engaged. Charged lengths 102a and 102b may be maintained at a charge sufficient to charge the plurality of EVs 104 simultaneously. For example, charged lengths 102a and 102b may be charged between about 110V to about 400,000V, AC or DC, or other voltage. For example, transmission lines may carry high voltage electricity at about 345,000V which may provide a stationary power source for powering charged lengths 102a and 102b with as much as 345,000V. In at least one embodiment, first portion 106e1 may be configured to condition the charge for charging the EV 104. For example, first portion 106e1 may be configured to step down, or otherwise condition, the energy supplied with charged lengths 102a and 102b. Currently available DC fast chargers may require inputs of 480+ volts and 100+ amps (50-60 kW). In at least one embodiment, first portion 106e1 and/or second portion 106e2 are configured to supply about 480+ volts and 100+ amps, about 350 kW of DC power, or other voltage or power, as may be desired, to charge the EV 104 with which it is electrically connected.

Electrical connector 106e1 may have an end portion 114 which may dispose electrical contacts adapted to electrically connect with charged lengths 102a and 102b or second portion 106e2, for example end portion 116. Second portion 106e2 may be configured to electrically connect with charged lengths 102a and 102b and first portion 106e1 while moving about a length of longitudinally extending charging strip or rail 102. For example, second portion 106e2 may have an end portion 116 with electrical contacts disposed to electrically connect with electrical contacts disposed with end portion 114 of first portion 106e1. End portions 114 and 116 may have non-planar outer surfaces which may configure them to mechanically guided and align electrical contacts for an electrical connection therebetween.

End portions 114 and 116 may be configured to be guided and to be held together to maintain an electrical connection therebetween, as EV 104 moves about charged lengths 102a and 102b. For example, end portions 114 and 116 may have nonplanar surfaces or mechanical or magnetic couplers. In at least one embodiment, end portions 114 and 116, and/or electrical contacts, are configured to magnetically couple and maintain an electrical contact between electrical connectors 106e1 and 106e2. In an embodiment wherein end portions 114 and 116 have non-planar outer surfaces and are configured to mechanically or magnetically couple, guiding and coupling and decoupling end portions 114 and 116 may be easily achieved. For example, EV 104 may be decoupled from longitudinally extending charging strip or rail 102 by simply moving away from longitudinally extending charging strip or rail 102.

In at least one embodiment, at least one electrical connector comprises a first portion configured to electrically connect to the EV and to the at least one electrically charged length or to a second portion. For example, electrical connector 106b may be configured to electrically connect with charged lengths 102a and 102b. Alternatively, or additionally, electrical connector 106b may be configured to electrically connect with, or to, a second portion such as electrical connector 106c, 106d, or 106e2. The second portion is configured to electrically connect with the first portion and charged lengths 102a and 102b.

A first portion of the electrical connector may be held with EV 104, such as 106b and 106e1, and be in electrical contact with EV 104's existing charging system. The first portion may be configured to condition the electrical charge of charged lengths 102a and 102b to a desired, or preset, electrical charge for charging EV 104.

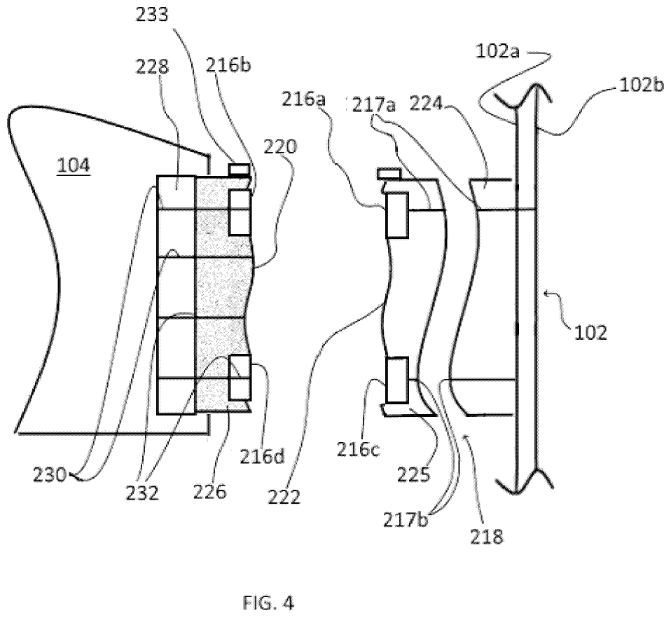

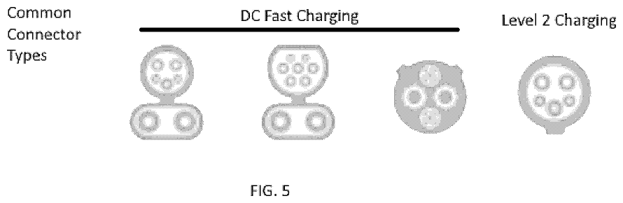

FIG. 4 shows another embodiment of electrical connectors that may be used with system 100. In this cross-sectional illustrative example, EV 104 may be manufactured to dispose electrical contacts for charging or may be fitted with an adapter 226. For example, a first portion of an electrical connector may be a component part of the EV for charging at charging station 101. An adapter 226 may be configured to adapt with an existing charging system on EV 104, such as charging port 228 on EV 104. For example, EV 104 may have charging port 228 with a configuration as shown in FIG. 5, or other configuration. Existing charging port 228 may have electrical connectors and receptacles 230 configured for receiving a plug and charging EV 104. Adapter 226 may be configured to plug into existing charging port 228 and extend electrical connectors and receptacles 230 with electrical connectors and receptacles 232. For example, upon adapting EV 104 with adapter 226, EV 104 may retain its configuration for receiving a plug for charging.

In at least one embodiment, plugging adapter 226 into EV 104 configures EV 104 to be charged with its original means for charging, such as with a plug having a configuration as shown in FIG. 5, and to be charged with charging station 101. Adapter 226 may have a similar, or same, plug-in configuration as existing charging port 228 and dispose electrical contacts 216b and 216d. Adapter 226 may have electrical contacts 216b and 216d disposed to become electrically connected with electrical contacts 216a and 216c, disposed with electrical connector 218.

A first portion of an electrical connector, such as adapter 226, and/or a second portion of an electrical connector, such as such as electrical connector 218 may have an electronic, mechanical, and/or magnetic guide or coupler configured and disposed to guide or releasably couple at least two electrical contacts, such as electrical contacts 216b and 216d with the longitudinally extending charging strip or rail 102 or with a second portion, such as electrical connector 218, for charging EV 104.

In at least one embodiment, electrical connector 218 may have an extending portion 224 and a head portion 225. Head portion 225 may dispose electrical contacts 216a and 216c in a configuration for electrically connecting with electrical contacts 216b and 216d. For example, head portion 225 may have a non-planar outer surface 222 configured for guiding, substantially mating with, or becoming adjacent to, outer surface 220 of adapter 226. Non-planar outer surfaces 220 and 222 may be configured to mechanically guide electrical contact 216a to electrical connect with electrical contact 216b and to guide electrical contact 216c to electrical connect with electrical contact 216d, upon extending head 225 toward adapter 226. Electrical connector 218 may have conductors 217a and 217b configured and disposed to electrically connect contact 216a with charged length 102a and electrical connect contact 216b with charged length 102b.

At least one portion of an electoral connector may be configured to be electronically guided and/or coupled for making or maintaining an electrical contact between EV 104 and longitudinally extending charging strip or rail 102. For example, extending portion 224 may be configured to extend from longitudinally extending charging strip or rail 102 and place head 225 adjacent adapter 226. Extending portion 224 may be moved on longitudinally extending charging strip or rail 102 at a speed substantially the same as EV 104 and a height of head 225 may be adjusted with extending portion 224. Upon moving head 225 to become adjacent adapter 226, electrical contacts may be acquired between electrical contact 216a and electrical contact 216b and between electrical contact 216c and electrical contact 216d. Maintaining the electrical connection between head 225 and adapter 226 may cause EV 104 to be charged as it moves about a length of charging rail or strip 102. Extending portion 224 may be configured to guide head 225 to electrically connect with adapter 226 and to maintain an electrical connection while EV 104 is in motion.

Positioning head 225 for electrically connecting with adapter 226 may be acquired or aided electronically by having one or more sensors and/or wireless communicators disposed EV 104 and/or system 100. For example, a driver of EV 104 may wirelessly communicate with system 100 and request a charge. The charge may be granted and a speed may be communicated to EV 104, or a driver of EV 104, with controller 110. EV 104 may substantially obtain and maintain the communicated speed and enter a designated lane or position on the road for charging. Electrical connector 218 may be moved at the communicated speed upon EV 104 entering the designated position at the communicated speed.

A vertical position of head 225, for aligning with adapter 226 and making an electrical connection therebetween, may be acquired electronically with one or more of sensors, wireless communications, and/or mechanically such as with shapes of outer surfaces of head 225 and adapter 226, or magnetically. For example, a vertical position of adapter 226 may be communicated to controller 110 upon EV 104 requesting a charge. One or more sensors may be disposed with EV 104 and/or system 100 and system 100 may be configured for vertical and/or horizontal positioning of electrical connector 218, or head 225, for making, and maintaining, an electrical connection between head 225 and adapter 226. For example, a sensor, such as an image sensor or RFID, or other wireless communicator may be disposed with adapter 226 and/or head 225 or other portion of system 100 and/or EV 104. Upon acquiring the position of adapter 226, extending portion 224 may extend head 225 to electrically connect with adapter 226. An alignment, or guiding, of contacts 216a and 216c with contacts 216b and 216d may also be acquired magnetically, and/or mechanically, such as with non-planar surfaces 222 and 220 and/or coupler 233.

Upon an electrical connection being acquired between adapter 226 and electrical connector 218, the electrical connection may be maintained as EV 104 moves about a length of charged lengths 102a and 102b for charging. For example, changes in speed, distance from charging strip or rail, vertical and horizontal position, and/or other parameter of EV 104 may be sensed or communicated, wirelessly or wired, through the electrical contacts for example. Extending portion 224 may be configured to adjust the position and/or speed of head 225 to maintain the electrical connection for charging.

In at least one embodiment, head 225 and adapter 226 are configured to be guided and/or couple and decouple. For example, guiding, coupling, and decoupling may be performed electronically, magnetically, or mechanically. In at least one embodiment, head 225 and/or adapter 226 are configured to be mechanically and/or magnetically coupled. For example, one or more of electrical contacts 216a, 216b, 216c, and 216d, head 225, and/or adapter 226 may be magnetic, or be configured to become magnetic such as with an electromagnet.

A mechanical coupling may be acquired between head 225 and adapter 226 as illustrated with guider and/or coupler 233. For example, coupler 233 may have a portion disposed with adapter 226 and head 225, wherein the coupler portions may be configured and disposed to guide and/or couple and uncouple adapter 226 with head 225. A magnetic or mechanical coupler may also be configured to provide for aligning or guiding of head 225 to contact adapter 226.

Head 225 and adapter 226 may be configured to have a desired coupling force to maintain an electrical connection therebetween and to decouple when desired. For example, upon coupling, the coupling force may be sufficient to move or pull electrical connector 218 along charged lengths 102a and 102b with EV 104. Additionally, extending portion 124 may be flexible or otherwise configured to allow movement of head 225 in a vertical and/or horizontal direction to maintain an electrical connection between head 225 and adapter 226 while EV 104 is moving. The coupling force may be sufficient for maintaining the electrical contact and for being exceed to cause decoupling, upon movement of EV 104 away from a charging position or lane or the departure of electrical connector 218 from charged lengths 102a and 102b.

In at least one embodiment of the present disclosure, EV charging system 100 has an electrical connector 106 comprising a first and second portion. The first portion may be an adapter adapted to be held with EV 104 and electrically communicate with an existing charging system disposed with EV 104. For example, an adapter 228 may be configured to plug into an existing charging port, such as a charging port configuration shown in FIG. 5, on EV 104, and be configured for electrically connecting with the second portion. Adapter 228 may be configured and disposed to receive power for charging EV 104 from longitudinal charging strip or rail 102 and a charger adapted to fit with the existing charging port on EV 104, thus configuring EV 104 to be charged with longitudinally extending charging strip or rail 102 and the charger adapted to charge EV with the existing charging port.

In at least one embodiment, at least one electrical connector has an electrical, mechanical, or magnetic guide or coupler configured and disposed to guide or releasably couple the least two electrical contacts with the longitudinally extending charging strip or rail for charging the EV.

In at least one embodiment, an EV charging adapter is configured to be held with the EV and electrically connect with an existing charging system disposed with the EV. For example, an adapter may have at least two electrical contacts configured and disposed to electrically connect with electrically charged lengths disposed with a charging strip or rail. Each of the electrical contacts being configured and disposed to supply power to the EV for charging. The adapter may be adapted to electrically connect with any part of the charging system disposed with the EV for supplying power to the EV for charging. It may be convenient for the adapter to be configured and disposed to electrically connect with, or plug into, an existing charging port disposed with the EV for charging.

In at least one embodiment, a charging adapter has at least two electrical contacts for electrically connecting with electrically charged lengths disposed with a charging strip or rail and is configured and disposed to receive power for charging the EV from a charger adapted to fit with the existing charging port on the EV, thus configuring the EV to be charged with the longitudinally extending charging strip or rail and the charger adapted to charge the EV with the existing charging port.

In at least one embodiment, the EV charging adapter has an electrical, mechanical, or magnetic guide or coupler configured and disposed to guide and/or releasably electrically couple the at least two electrical contacts with the longitudinally extending charging strip or rail. The adapter may be configured to condition an electrical charge or current of the longitudinally extending charging strip or rail for charging the EV with which it is held.

A method of charging an EV, while the EV is in motion, may comprise: placing the EV in a charging lane or position and obtaining a speed for charging; disposing electrical contacts with the EV for charging; and electrically connecting the disposed electrical contacts to electrically charged lengths; charging the EV; and disconnecting the electrical contacts from the electrically charged lengths.

The step of electrically connecting the disposed electrical contacts to the electrically charged lengths may comprises moving an electrical connector in electrical connection with the charged lengths and electrically contacting the electrical contacts disposed on the EV. A speed or location of the disposed electrical contacts for the electrically connecting of the EV to the electrically charged lengths may be sensed or wirelessly communicated with the presently disclosed system for aiding in the electrical connection of the EV to the electrically charged lengths for charging. Additionally or alternatively, the electrical connection of the EV to the electrically charged lengths may be acquired and/or maintained by mechanically or magnetically guiding and/or coupling an electrical connector for the electrical connecting

The presently disclosed system may be configured to condition the electrical charge of an external power source and/or condition the electrical charge or current of the electrically charged lengths for charging the EV. For example, the electrical charge or current of the external power source may be continuously conditioned to substantially maintain a desired charge of the longitudinally extending charging strip or rail. For example, the charge of the longitudinally extending charging strip or rail may be maintained at about 480V DC or for providing up to, at least, or about 350 kWh to each EV being charged. An electrical connector disposed with the EV may be configured to condition the electrical charge of the longitudinally extending charging strip or rail for charging the EV to which it is electrically connected. For example, the electrical connector may condition the charge of the longitudinally extending charging strip or rail for charging the EV with a charge of about 350V DC, 240V AC, or other charge needed to charge the EV to which it is electrically connected.

A method of charging an EV while the EV is in motion may comprise: wirelessly sending a request for charging the EV to an EV charging station; placing the EV in a charging lane or position and obtaining a charging speed; disposing electrical contacts with the EV for charging, for example exposing an existing charging port or contacts on an adapter; and electrically connecting the disposed electrical contacts to electrically charged lengths disposed with the charging station and maintaining the electrical connection upon the EV moving about a length of the electrically charged lengths.

A method of charging an EV while the EV is in motion may comprise wirelessly receiving by the EV, or driver thereof, in response to a request for charging the EV, a grant to charge the EV, a charging lane or position, and/or a charging speed for charging the EV. The wirelessly sending a request for charging the EV to the charging station may include information about the requested charge such as information of a desired charge to receive, positioning of the electrical contacts, a desired speed, or other information about the EV or a parameter of the requested charge.

Electrically connecting the disposed electrical contacts to the electrically charged lengths may comprise moving an electrical connector, or portion thereof, in electrical connection with the charged lengths and electrically contacting the electrical connector with the electrical contacts disposed on the EV. For example, a speed and location of the disposed electrical contacts for the electrically connecting to the electrically charged lengths may be sensed or wirelessly communicated. The electrical charge or current to and/or from the electrically charged lengths may be conditioned for charging the EV.

The present disclosure provides for an EV charging system & method for charging EVs while they are in motion. The embodiments disclosed herein are not to limit the claims as other and different embodiments will become apparent to those skilled in the art upon reading the present disclosure. For example, EVs may be manufactured or sold having electrical contacts disposed with the EV for electrically connecting with the charging strip or rail and charging. Illustratively, an EV having a first portion of an electrical connector may be delivered to a customer ready for charging at charging station 101. The disclosed longitudinally extending charging strip or rail may be linear, curved or even angular. The presently disclosed system may have one or more longitudinally extending charging strips or rails which may be in electrical connection with an external power source in series or in parallel. The longitudinally extending charging strip or rail may be disposed above, below, or along a side of the EVs for charging. An electrical connector for electrically connecting the EV to the longitudinally extending charging strip or rail may have a variety of configurations and may be a single component or multi-component. The electrical connector may be configured to electrically connect anywhere within the EV's charging system or directly with the EV's battery and may be configured to electrically connect above, below, or along a side of the EVs.

It will be understood that the examples of patents, published patent applications, and other documents which are included below in this application may have disclosures that may possibly be used or not be used or useable in any one or more embodiments of the application. These references, or portions thereof, are hereby incorporated by reference herein. The purpose of incorporating U.S. patents, foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

Some examples of features which may possibly be utilizable by at least one possible embodiment may possibly be found in the following which are incorporated by reference herein: U.S. Ser. No. 10/988,042, titled “Vehicle charging system”, filed 2019 Oct. 15, by Chase, Arnold; U.S. Ser. No. 10/988,044, titled “Automatic plug-and-pay with multi-factor authentication for fueling vehicles”, filed 2018 Mar. 26, by Erb, Dylan et al.; U.S. Ser. No. 11/007,891, titled “Fast electric vehicle charging and distributed grid resource adequacy management system”, filed 2020 Oct. 30, by Kamal, Anurag et al.; U.S. Ser. No. 11/027,621, titled “Vehicle and charging system”, filed 2019 Mar. 29, by Kinomura, Shigeki; U.S. Ser. No. 11/046,201, titled “Electric vehicle charging station system”, filed 2019 Mar. 25, by Mondello, Antonino et al.; U.S. Ser. No. 11/052,776, titled “Charging station for electrified vehicles”, filed 2015 Sep. 24, by Christen, Erik J. et al.; U.S. Ser. No. 11/052,779, titled “Charging station”, filed 2019 Jul. 9, by Köhler, David; U.S. Ser. No. 11/059,381, titled “Controlling electric vehicle charging currents”, filed 2018 Nov. 6, by Ahtikari, Juss; U.S. Ser. No. 11/077,760, titled “Precharging for direct current fast charging”, filed 2019 Feb. 26, by Fong, Wai Hwa et al.; U.S. Ser. No. 11/091,041, titled “Electric system for a motor vehicle comprising a switching matrix, and motor vehicle”, filed 2020 Jul. 14, by Molina, Vincent; U.S. Ser. No. 11/091,044, titled “Method for preparing a vehicle”, filed 2018 May 10, by Enthaler, Achim et al.; U.S. Ser. No. 11/091,046, titled “System for providing an interface to electric vehicle charging stations”, filed 2015 Feb. 6, by Wild, Nick et al.; U.S. Ser. No. 11/091,050, titled “Charging station for charging an electric vehicle”, filed 2019 Aug. 1, by Burgermeister, Andreas et al.; U.S. Ser. No. 11/091,052, titled “Wireless charging station device with frequency selection and vehicle position determination”, filed 2019 May 1, by Hocke, Fredrik et al.; U.S. Ser. No. 11/097,626, titled “Vehicle electrical systems, charging system, charging station, and method for transmitting electrical energy”, filed 2017 Jun. 27, by Pfeilschifter, Franz et al.; U.S. Ser. No. 11/097,630, titled “Method for managing the energy demand of a charging station for an electric vehicle”, filed 2019 Feb. 26, by Freitag, Steffen; US US20210090140, titled “METHODS AND SYSTEMS FOR CHARGING OF ELECTRIC VEHICLES”, filed 2020 Nov. 23, by Khoo, Lin-zhuang et al.; US US20210101500, titled “CHARGING STATION WITH DYNAMIC CHARGING CURRENT DISTRIBUTION”, filed 2018 Jul. 24, by Brombach, Johannes et al.; US US20210101501, titled “METHOD AND CHARGING DEVICE FOR CHARGING A HIGH-VOLTAGE BATTERY OF AN ELECTRIC VEHICLE”, filed 2020 Dec. 18, by Neitz, Marc et al.; US US20210114476, titled “SYSTEMS AND METHODS FOR AUTOMATIC CONNECTED CHARGER”, filed 2019 Oct. 22, by Spaninks, Arjan; US US20210114478, titled “CHARGING STATION FOR CHARGING ELECTRIC VEHICLES, COMPRISING A CONTROL DEVICE FOR DETERMINING AN EQUIVALENT STORAGE CAPACITY OF A VIRTUAL PRECHARGE STORE, AND ASSOCIATED METHOD”, filed 2019 Apr. 12, by Brombach, Johannes; US US20210122258, titled “EV CHARGING STATION”, filed 2019 Oct. 28, by Sham, Wellen; US US20210126478, titled “CHARGING STATION”, filed 2020 May 8, by Park, Seungjong et al.; US US20210129692, titled “CHARGING STATION FOR ELECTRIC VEHICLES”, filed 2021 Jan. 12, by Siaenen, Thorbjorn et al.; US US20210129701, titled “CHARGING STATION HAVING DYNAMIC CHARGING CURRENT DISTRIBUTION”, filed 2018 Jul. 26, by Brombach, Johannes et al.; US US20210138924, titled “METHOD AND CHARGING DEVICE FOR CHARGING A HIGH-VOLTAGE BATTERY OF AN ELECTRIC VEHICLE”, filed 2020 Dec. 18, by Neitz, Marc et al.; US US20210170901, titled “CHARGING STATION AND METHOD FOR CHARGING ELECTRIC VEHICLES”, filed 2019 Apr. 12, by Brombach, Johannes et al.; US US20210195501, titled “Wireless Network Pairing for Wireless Electric Vehicle Charging”, filed 2020 Dec. 21, by Bittner, Markus et al.; US US20210221255, titled “CHARGING METHOD FOR AN ELECTRIC VEHICLE”, filed 2020 Dec. 4, by Lenz, Michael; US US20210237599, titled “CHARGING STATION FOR ELECTRIC VEHICLES”, filed 2021 Apr. 23, by Müller-winterberg, Christian et al.; US US20210237610, titled “INTELLIGENT ELECTRIC-VEHICLE CHARGING STATION”, filed 2019 Oct. 12, by Zheng, Zhengxian et al.; US US20210245614, titled “ELECTRIC VEHICLE CHARGING SYSTEMS AND PLATFORMS”, filed 2021 Jan. 23, by Flynn, Cameron et al.; US US20210245619, titled “CHARGING SYSTEM AND METHOD OF A BATTERY OF AN ELECTRIC VEHICLE”, filed 2021 Feb. 8, by Ferrari, Massimo; US US20210252989, titled “Charging Station and System for Electric Vehicles”, filed 2021 Feb. 15, by Price, Marcus et al.; US US20210252990, titled “PILOT CONTROL CIRCUIT FOR CHARGING A VEHICLE WITH A CHARGING STATION”, filed 2020 Feb. 17, by Wang, Chih-lun; US US20210256793, titled “SYSTEM FOR OPERATING ELECTRIC-VEHICLE CHARGING STATION”, filed 2020 Aug. 11, by Noh, Soon-yong; and US US20210261016, titled “CHARGING SYSTEM FOR ELECTRIC VEHICLES”, filed 2021 May 11, by Kledewski, Ingo.

1. An EV charging system comprising:
a longitudinally extending charging strip or rail having at least one electrically charged length;
an external power source in electrical connection with the at least one electrically charged length;
at least one electrical connector configured and disposed to electrically connect an EV to the longitudinally extending charging strip or rail and charge the EV, while the EV and a connected electrical connector are moving along a length of the longitudinally extending charging strip or rail.

2. The EV charging system of claim 1 comprising at least two of the electrical connectors and being configured to charge at least two EVs simultaneously, while each of the EVs are moving along a length of the longitudinally extending charging strip or rail.

3. The EV charging system of claim 1, wherein the at least one electrical connector comprises a first portion configured and disposed to electrically connect the EV to the longitudinally extending charging strip or rail or to a second portion, the second portion being configured to electrically connect with the longitudinally extending charging strip or rail.

4. The EV charging system of claim 3, wherein the first portion is a component part of the EV or an adapter adapted to be held with the EV and electrically connect with an existing charging system disposed with the EV.

5. The EV charging system of claim 4, wherein the adapter is configured to plug into an existing charging port on the EV.

6. The EV charging system of claim 5, wherein the adapter is configured and disposed to receive power for charging the EV from a charger adapted to fit with the existing charging port on the EV, thus configuring the EV to be charged with the longitudinally extending charging strip or rail and the charger adapted to charge the EV with the existing charging port.

7. The EV charging system of claim 1, wherein the at least one electrical connector has an electronic, mechanical, or magnetic guide or coupler configured and disposed to guide or releasably couple the at least two electrical contacts with the longitudinally extending charging strip or rail for charging the EV.

8. The EV charging system of claim 4, wherein the first portion is configured to condition the electrical charge of the longitudinally extending charging strip or rail to a desired, or preset, electrical charge for charging the EV.

9. The EV charging system of claim 1, wherein the longitudinally extending charging strip or rail and the external power source are configured to provide at least 350 kW power to each of the EVs being charged.

10. The EV charging system of claim 1 comprising a controller, the controller being configured and disposed to control at least one of:
a) an electrical connection between the EV being charged and the at least one electrically charged length;
b) a power level or condition to each of the EVs being charged;
c) a speed of the at least one electrical connector about the longitudinally extending charging strip or rail;
d) a position of the at least one electrical connector;
e) a speed of the EV being charged;
f) a position of the EV being charged;
g) disconnecting the EV being charged from the longitudinally extending charging strip or rail;
h) wirelessly receiving a request to charge the EV; and
i) wirelessly sending a grant to charge the EV.

11. An EV charging adapter configured to be held with the EV and electrically connect with an existing charging system disposed with the EV, the adapter comprising:
at least two electrical contacts configured and disposed to electrically connect with a longitudinally extending charging strip or rail, while the EV is moving about a length of the longitudinally extending charging strip or rail; and
each of the electrical contacts being configured and disposed to supply power to the EV for charging.

12. The EV charging adapter of claim 11 being configure and disposed to electrically connect with an existing charging system or plug into a charging port disposed with the EV for charging.

13. The EV charging adapter of claim 12 being configured and disposed to receive power for charging the EV from a charger adapted to fit with the existing charging port on the EV, thus configuring the EV to be charged with the longitudinally extending charging strip or rail and the charger adapted to charge the EV with the existing charging port.

14. The EV charging adapter of claim 11 comprising an electrical, mechanical, or magnetic guide or coupler configured and disposed to guide or releasably electrically couple the at least two electrical contacts with the longitudinally extending charging strip or rail.

15. The EV charging adapter of claim 11 being configured to condition an electrical charge or current of the longitudinally extending charging strip or rail to charge the EV with which it is held.

16. A method of charging an EV, while the EV is in motion, comprising:
placing the EV in a charging lane or position and obtaining a speed for charging;
disposing electrical contacts with the EV for charging;
electrically connecting the disposed electrical contacts to electrically charged lengths;
charging the EV; and
disconnecting the electrical contacts from the electrically charged lengths.

17. The method of claim 16, wherein the step of electrically connecting the disposed electrical contacts to the electrically charged lengths comprises moving an electrical connector in electrical connection with the charged lengths and electrically contacting the electrical contacts disposed on the EV.

18. The method of claim 16 comprising sensing, or wirelessly communicating, a speed or location of the disposed electrical contacts for the electrically connecting of the EV to the electrically charged lengths.

19. The method of claim 16 comprising conditioning the electrical charge or current of the electrically charged lengths for charging the EV.

20. The method of claim 16 comprising electronically, mechanically, or magnetically guiding or coupling an electrical connector for the electrical connecting of the disposed electrical contacts to the electrically charged lengths.
